(19) United States
(12) Patent Application Publication
(10) Pub. No.: US 2019/0093612 A1
(43) Pub. Date: Mar. 28, 2019

(54) FUEL SYSTEM FOR AN INTERNAL COMBUSTION ENGINE AND A METHOD TO INCREASE THE VAPORIZATION TEMPERATURE OF A FUEL USED IN A FUEL SYSTEM

(71) Applicant: Scania CV AB, Södertäije (SE)

(72) Inventors: Kim KYLSTRÖM, Tullinge (SE); Tryggve NYLANDER, Tumba (SE)

(73) Assignee: Scania CV AB, Södertälje (SE)

(21) Appl. No.: 16/081,837

(22) PCT Filed: Feb. 2, 2017
(86) PCT No.: PCT/SE2017/050085

§ 371 Date: Aug. 31, 2018

(30) Foreign Application Priority Data
Mar. 7, 2016 (SE) 1650296-5

(51) Int. Cl. F02M 37/20; F02M 37/00

(52) U.S. Cl. CPC F02M 37/20; F02M 37/0052

(57) ABSTRACT

The present invention relates to a fuel system for an internal combustion engine, and a method to increase vaporization temperature of a fuel in the fuel system, which fuel system comprises a fuel tank, a fuel pump, a fuel filter device arranged downstream of the fuel pump, a first fuel conduit through which the fuel pump is arranged to supply fuel through the fuel filter device. A control valve, which opens and/or closes at a pre-determined pressure arranged upstream of the fuel filter device and downstream of the fuel pump, and a check valve arranged upstream of the fuel pump to prevent the fuel from flowing back to the fuel tank. A pressure, which is less than the pre-determined opening pressure of the control valve, is built up in the fuel pump after the internal combustion engine is turned off, for increasing vaporization temperature for hot start of the vehicle.

### CROSS-REFERENCE TO RELATED APPLICATION(S)

This application is a national stage application (filed under 35 § U.S.C. 371) of PCT/SE2017/050085, filed Feb. 2, 2017 of the same title, which, in turn claims priority to Swedish Application No. 1650296-5, filed Mar. 7, 2016 of the same title; the contents of each of which are hereby incorporated by reference.

### FIELD OF THE INVENTION

The present invention relates to a fuel system for an internal combustion engine, an internal combustion engine with such a fuel system, a vehicle with such a fuel system and/or internal combustion engine and a method to increase the vaporization temperature of a fuel used in a fuel system whereby it is possible to prevent vaporization of a volatile fuel at restart of a warm internal combustion engine.

### BACKGROUND OF THE INVENTION

Internal combustion engines such as diesel engines or Otto engines are at present used in various types of applications and vehicles, e.g. in heavy vehicles such as trucks or buses, cars, motorboats, watercraft, ferries or ships. Internal combustion engines are also used in industrial engines and/or engine-powered industrial robots, power plants, such as electric power plants which comprise a diesel generator, and in locomotives.

Internal combustion engines may be powered by volatile fuels, such as gasoline, ethanol or natural gas. They are provided with a fuel system for conveying the fuel from one or more fuel tanks to the engine's injection system. The fuel system comprises one or more fuel pumps which may be driven mechanically by the internal combustion engine or be driven by an electric motor. The fuel pumps create a fuel flow and pressure for conveying the fuel to the engine's injection system, which supplies it to the engine's combustion spaces.

The internal combustion engines operate in high temperatures, such as from 450° C. to about 1000° C. To be able to handle high operating temperatures, the internal combustion engine is provided with a coolant system. The coolant system is arranged such that it is able to cool the internal combustion engine when the temperatures created during the combustion process get higher. The coolant system comprises several components, e.g. an engine block, water pump, fan, thermostat, radiator, coolant, and coolant hoses. The water pump may be connected to the crankshaft of the engine. The engine coolant may comprise for example ethylene glycol, propylene glycol, and/or water. The coolant is arranged to flow through the coolant system into the engine block where it is circulated through the engine block and then fed back into the radiator. The fluid inside the radiator is then cooled for example during the vehicle motion. The phenomenon known as “heat soak” occurs when the engine is turned off and the combustion process is terminated. This terminates the momentum of the crankshaft, which in turn stops the turning of the water pump, and therefore the coolant is no longer circulated into the engine block. Therefore, the engine block and cylinder temperature increase for a period of e.g. approximately 3 to 10 minutes, depending on the engine design and additional components. The increased heat may cause the fuel to boil and thus vaporize or evaporate, whereby a restart of the vehicle is extremely difficult.

There have been attempts to solve the problem of fuel vaporization to enable an easier restart of the engine. For example DE19530261 shows a solution in which an electrically driven fuel pump is arranged to continue to feed fuel to the fuel system a short period after the engine has been turned off to build up pressure in the fuel system. This ensures that vapor lock is prevented at the fuel injector and a hot re-start is allowed. However, electrically driven fuel pumps are temperature sensitive and thus there is a risk for breakdown. Also such fuel pumps are expensive and thus increase the manufacturing costs of the vehicle. JPH0835459 shows another solution to rise fuel pressure immediately after the stoppage of an engine and restrain the occurrence of vapors by providing an open/close valve at a fuel return passage in series with a pressure regulator, closing the valve during the stoppage of the engine, and continuing to close the valve at the time of restart of an engine at high temperature. JP2009074408 discloses still another solution to minimize the delay of start of an engine due to vaporization of fuel in a fuel feed pipe between a tank and a pump in which a fuel pump is disposed in the fuel feed pipe for connecting an injector and the fuel tank. A check valve for preventing the fuel from reversely flowing to the fuel tank side is installed in the fuel feed pipe between the fuel tank and the fuel pump.

Despite known solutions in the field, there is a need to further develop a fuel system which reduces the risk for vaporization of fuel during a restart of a hot internal combustion engine and which reduces a risk for damage in the fuel system.

### SUMMARY OF THE INVENTION

The object of the present invention is to provide a fuel system which reduces the risk for vaporization of volatile fuels during start of a warm or hot internal combustion engine.

Further, it is an object of the invention to provide a fuel system and method that are easy to control, robust and do not require extensive constructional modifications to the existing fuel systems.

Also, another object of the invention is to provide a fuel system for an internal combustion engine which is compact and saves space.

A further object of the present invention is to provide a fuel system for an internal combustion engine in which fuel consumption is minimized.

Another object of the present invention is to provide a fuel system for an internal combustion engine in which the risk for damage is minimized.

The objects above are achieved with a fuel system, an internal combustion engine including the fuel system and a vehicle comprising the internal combustion engine, which all are defined in the appended claims. The objects are also achieved by a method to increase the vaporization temperature of a fuel used in a fuel system for an internal combustion engine as defined in the appended claims.

According to the first aspect of the invention the objects are attained by a fuel system for an internal combustion engine which fuel system comprises a fuel tank, a fuel pump, a fuel filter device arranged downstream of the fuel pump, a first fuel conduit through which the fuel pump is arranged to supply fuel through the fuel filter device. The fuel is then passed further to a high pressure circuit including a high pressure pump which supplies fuel to a fuel injector. In the fuel system of the invention, a control valve, which opens and/or closes at a pre-determined pressure, is arranged upstream of the fuel filter device and downstream of the fuel pump. A check valve is arranged upstream of the fuel pump to prevent the fuel from flowing back to the fuel tank. When the engine is turned off, the fuel pump will stop operating and the flow pressure of the fuel in the fuel system will rapidly decrease. The control valve has a pre-determined opening pressure and thus, when the pressure decreases under the pre-determined pressure, no fuel from the fuel pump is fed to the filter device. The opening pressure for the control valve is suitably pre-determined to be above atmospheric pressure. The fuel in the fuel pump will be pressurized up to the pre-determined pressure. If the pressure is above the pre-determined pressure, the control valve will open and let the fuel pass further in the fuel system. While the control valve is closed until the pressure is increased above the opening temperature, the check valve will prevent the fuel from flowing back to the fuel tank, whereby the remaining fuel in the fuel pump will be kept pressurized. When the pressure of the fuel rises, the vaporization or boiling temperature of the fuel rises. Therefore, during the hot start of the vehicle, defined above as hot soak, the fuel will not vaporize due to the higher vaporization temperature and it will be possible to feed fuel from the fuel pump to the injector in the high pressure circuit of the fuel system and thus start the engine. When the engine is started, the coolant system will start to function and thus, the engine may continue to operate. The present system will reduce the risk for vaporization of volatile fuels during the start of a warm or hot internal combustion engine. Also, the system is easy to control, robust and does not require extensive constructional modifications to the existing fuel systems. Further, the system is compact and space saving and does not essentially increase the weight of the vehicle, whereby fuel consumption is not increased.

The fuel pump is preferably mechanically driven and controlled by the engine speed of the internal combustion engine. Such pumps are not severely sensitive for heat and are therefore more robust than fuel pumps that are electrically driven.

The control valve may be arranged to be gradually opening and/or closing. In this way sudden pressure fluctuations in the fuel system may be prevented.

According to one variant of the invention a recirculation conduit is arranged upstream of the control valve and downstream of the fuel pump for recirculation of fuel back to the fuel pump and the check valve is arranged upstream of the fuel pump and the recirculation conduit. In this way the fuel may be recirculated in a closed circuit while it will still be pressurized when the pressure is below the opening pressure of the control valve.

According to one variant of the invention the recirculation conduit comprises a regulator for the fuel pump. The regulator controls the pressure inside the fuel pump and is suitably a valve device and arranged at the inlet of the recirculation conduit. According to one embodiment, the control valve is the fuel pump's regulator, which is located in the first fuel conduit downstream of the fuel pump and upstream of the fuel filter device. Suitably, the regulator has been moved from the fuel pump to the first fuel conduit. In this way, no further components in the fuel system would be required and thus the system could be further simplified.

The pre-determined opening pressure for the control valve is preferably set below a normal operational pressure of the fuel system. The normal operational pressure can be for example between 5-20 bar, but the pressure is preferably kept below the normal operational pressure to avoid risk for damage of the pump. The pre-determined opening pressure for the control valve is also preferably set such that the pressure increases the vaporization and/or boiling temperature of the fuel. Further, the vaporization and/or boiling temperature of the fuel is suitably set to be above the temperature of the engine after the engine has been turned off. This means that the pressure should be sufficient to raise the vaporization and/or boiling temperature above the temperature of the engine or engine block, since the temperature of the engine or engine block directly affects the temperature of the fuel pump.

According to one aspect of the invention, the pre-determined opening pressure of the control valve is set to from 1.2 to 2.5 times atmospheric pressure. Preferably, the pre-determined opening pressure of the control valve is set such that the vaporization temperature of the fuel is from 10 to 50° C. higher than the vaporization temperature of the fuel at atmospheric pressure. In this way it can be assured that the pressure in the fuel pump will not damage the pump while it is possible to raise the vaporization and/or boiling temperature of the fuel to be above the temperature of the fuel system after a warm engine has been turned off, whereby a restart of the vehicle will be possible while the engine is still hot.

The fuel used in the fuel system may be any volatile fuel, such as ethanol, methane, propanol or gasoline or a mixture thereof. According to one variant, the fuel is ethanol, which is commonly used in different types of vehicles today. Also, ethanol is a more environmentally friendly fuel than petroleum-based fuels. For example, the fuel may be ED95 or E85. ED95 is an ethanol-based fuel comprising ethanol in about 95% by volume and which is usable in adapted diesel engines. E85 is an ethanol-based fuel usually comprising ethanol in an amount of 85% by volume and gasoline in an amount of about 15% by volume, but the volume ratio may be varied.

The present invention also relates to an internal combustion engine which comprises the fuel system as defined above. The present invention further relates to a vehicle, which comprises the internal combustion engine.

The present invention also relates to a method to increase the vaporization temperature of a fuel used in a fuel system for an internal combustion engine. The fuel system comprises a fuel tank, a fuel pump, a fuel filter device arranged downstream of the fuel pump, a first fuel conduit through which the fuel pump is arranged to supply fuel through the fuel filter device, wherein the method comprises the steps:

a) arranging a control valve upstream of the fuel filter device and downstream of the fuel pump, in order to control the fuel flow from the fuel pump;

b) arranging a check valve upstream of the fuel pump in the first fuel conduit to prevent the fuel from flowing back to the fuel tank;

c) controlling the control valve in such a way that it opens at a pre-determined pressure;

wherein a pressure, which is less than the pre-determined opening pressure of the control valve, is built up in the fuel pump after the internal combustion engine is turned off.

By the method the same effects as described above in connection with the fuel system are obtained. Thus, when the engine is turned off, the fuel in the fuel pump will be pressurized, since the control valve has a pre-determined opening pressure and the check valve will prevent the fuel from flowing back to the fuel tank. By the present method it will thus be possible to reduce the risk for vaporization of volatile fuels during the start of a warm or hot internal combustion engine.

The method may further comprise a step of:

d) recirculating a part of the fuel via a recirculation conduit back to the low pressure pump.

In this way, the pressure in the fuel pump may be regulated. Also, as mentioned above, in this way the fuel may be recirculated in a closed circuit while it will still be pressurized when the pressure is below the opening pressure of the control valve.

According to one aspect of the invention, the step (b) also comprises controlling the control valve electrically, via a control device connected to the control valve via a communications bus. In this way it will be possible to integrate the control of the control valve to a common vehicle control system.

Further, according to one variant, the step c) may comprise providing a valve device at the inlet to the recirculation conduit. In this way it will be possible to control the pressure inside the fuel pump and the recirculation flow in an effective way.

Further advantages and features of the invention will be described below in the detailed description with reference to the appended drawings.

### BRIEF DESCRIPTION OF THE DRAWINGS

Preferred embodiments of the invention are described below by way of examples with reference to the attached drawings, in which:

FIG. 1 is a schematic side view of a vehicle provided with a fuel system for a combustion engine according to the present invention,

FIG. 2 is a connection diagram for a fuel system according to the present invention,

FIG. 3 is a diagram showing vapor pressure of ethanol at different temperatures, and

FIG. 4 is a flowchart of a method to increase the vaporization temperature of a fuel used in a fuel system for an internal combustion engine according to the invention.

### DETAILED DESCRIPTION OF THE INVENTION

The invention is described below with reference to the fuel system and method generally described above.

The present invention relates to a part of a fuel system which is often called low pressure circuit or low pressure part of the fuel system. The main purpose of the fuel pump is to feed fuel from the fuel tank further through the fuel filter and to the high pressure circuit of a fuel system in which a high pressure pump is provided to feed the fuel further to an injector. By the fuel pump in this connection is thus meant a low pressure pump having operational pressure from about 500 to 2000 kPa (5 to 20 bar), suitably from 9 to 14 bar. Suitably, the fuel pump is operated by the internal combustion engine and controlled by the speed of the internal combustion engine, whereby a robust and reliable supply of the fuel from the fuel tank further through the fuel filter to the high pressure circuit of the fuel system is provided.

The check valve used in the fuel system of the present invention prevents the fuel from flowing back to the fuel tank and thereby assists in pressurizing the fuel in the fuel pump. The check valve may be e.g. a diaphragm valve.

The control valve of the present invention is mechanically or electrically controlled. In any case, the control valve should be configured so that it has a minimal impact in the normal operation of the fuel system and the internal combustion engine. For example the flow area should be sufficiently large so that back pressure in the system is minimized. In case the control valve is electrically operable or controllable, it is possible for the valve to be closed and opened in a flexible way. However, by means of a mechanically controllable valve a simple and more cost-effective fuel system may be provided. The mechanically controllable valve may for example comprise a spring means that has a pre-determined resistive force allowing the opening of the valve at a pre-determined pressure. Operating the valve on the basis of predetermined parameters results in a fuel system in which the fuel pump is pressurized when desired, i.e. when the engine is turned off, thereby minimizing the fuel system's energy demand and hence also the fuel consumption. The electrically operable valve may be for example a solenoid valve but may be any desired electric valve.

In case the control valve is electrical, it may be arranged in communication with a control unit which is with advantage connected to a CAN bus. The vehicle's other control units may also be connected to the CAN bus, making it possible for the valve's control unit to receive information from them. This information may with advantage be used as control parameters in operating the valve. The valve's control unit may either be a separate unit confined to operating the valve or be connected to the fuel pump's control unit, which takes with advantage the form of the control unit of the electric motor which operates the fuel pump.

In case the control valve is electrically controlled, the fuel system of the present invention may also comprise a pressure sensor which is preferably provided downstream of the fuel pump or the fuel filter device to measure the fuel pressure after the fuel pump or the fuel filter device, and is in communication via the CAN bus with the valve's control unit to enable the latter to decide whether activation of the valve is necessary, i.e. to close the fuel supply from the fuel pump. Alternatively a pressure sensor is provided downstream of the fuel pump and upstream of the fuel filter device or both upstream and downstream of the fuel filter device. The pressure sensor is preferably provided with control logic and is in direct communication with the CAN bus. Alternatively the pressure sensors are in communication with the fuel pump's control unit, which itself is in communication with the CAN bus and hence with the valve's control unit.

Further features and advantages of the invention are indicated below with reference to the appended drawings showing an example embodiment of the present invention.

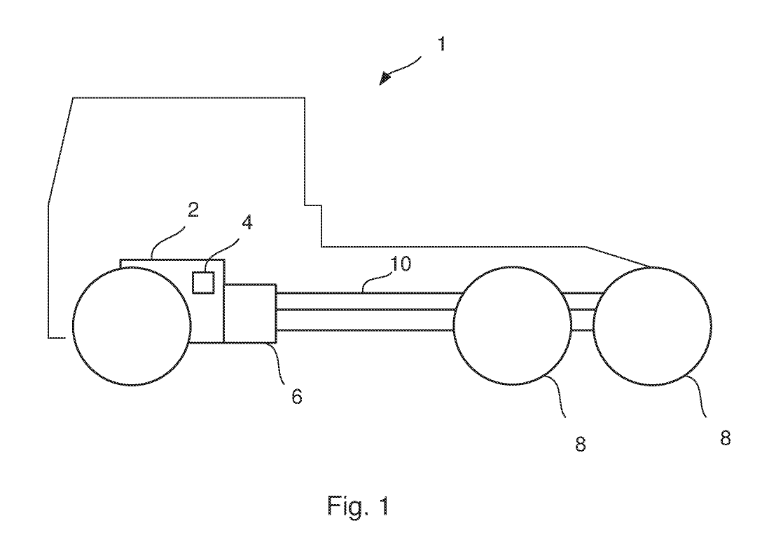

FIG. 1 is a schematic side view of a vehicle 1 provided with a fuel system 4 for an internal combustion engine 2 according to the present invention. The engine 2 is connected to a gearbox 6 which is itself connected to the vehicle's tractive wheels 8 via a transmission. The vehicle comprises also a chassis 10.

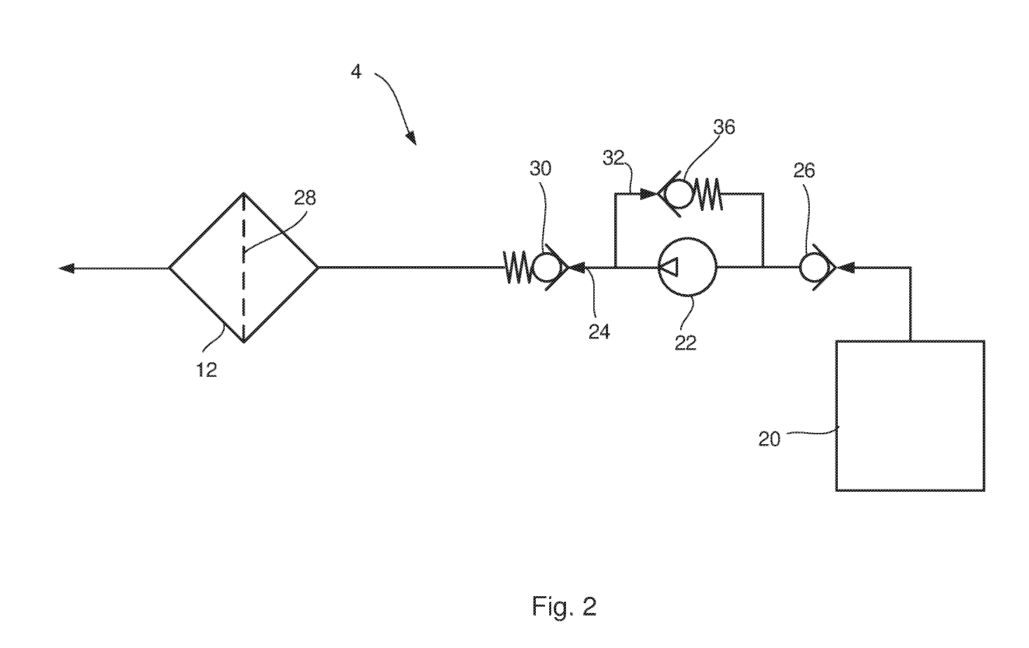

FIG. 2 is a connection diagram for a fuel system 4 for an internal combustion engine 2 according to the present invention. The system comprises a fuel tank 20, a fuel pump 22, a fuel filter device 12 and an internal combustion engine 2 (shown in FIG. 1). The fuel pump 22 pumps fuel from the tank 20 through the fuel filter device 12, which comprises a filter element 28, situated downstream of the fuel pump 22, to a high pressure circuit of the fuel system (not shown). The fuel is pumped in the high pressure circuit by means of a high pressure pump to an injection device, which injects fuel to the internal combustion engine. Further, a control valve 30, which opens and/or closes at a pre-determined pressure, is arranged upstream of the fuel filter device 12 and downstream of the fuel pump 22. A check valve 26 is arranged upstream of the fuel pump 22 to prevent the fuel from flowing back to the fuel tank 20. The fuel pump 22, which is a low-pressure pump, is driven by the speed of the internal combustion engine. Thus, when the internal combustion engine is turned off, the fuel pump will stop operation and the pressure in the fuel system will rapidly decrease. Since the control valve 30 has a pre-determined opening pressure and since the check valve 26 will prevent the fuel from flowing back to the fuel tank 20, it will be possible to keep a specific volume inside the pump and maintain a fuel pressure at a level of up to the pre-determined opening pressure of the control valve 30. The opening pressure for the control valve 30 may be pre-determined to be above atmospheric pressure and thus, the fuel in the fuel pump 22 will be pressurized even when the pressure has dropped under the predetermined pressure. At the same time, the check valve 26 will prevent the fuel from flowing back to the fuel tank 20, whereby the remaining fuel in the fuel pump 22 will be kept pressurized. The fuel pump also comprises a recirculation conduit 32 which is arranged upstream of the control valve 30 and downstream of the fuel pump 22 for recirculation of at least part of the fuel back to the fuel pump 22, and the check valve 26 is arranged upstream of the fuel pump 22 and the recirculation conduit 32. A regulator 36 is placed in the recirculation circuit 32 and the regulator controls the pressure in the fuel pump 22. According to one variant of the invention, which is not shown in the drawings, the regulator 36 for the fuel pump is instead arranged at the inlet of the recirculation conduit 32, and constitutes the control valve 30 of the fuel pump 22. This means that the regulator 36 has been moved from the fuel pump 22 to the first fuel conduit 24 downstream of the fuel pump 22 and upstream of the fuel filter device 12.

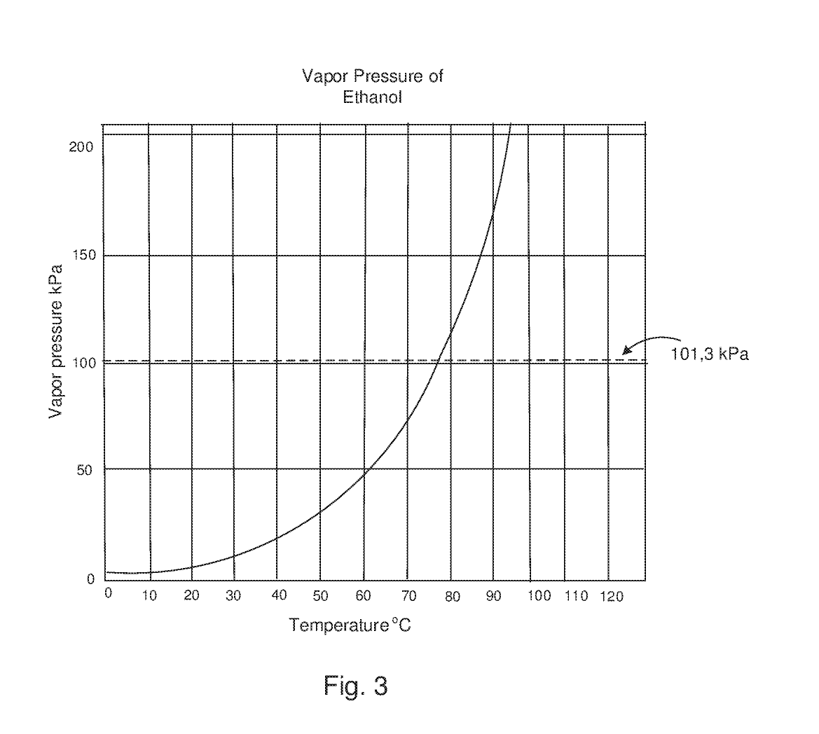

When the pressure of the fuel rises, the vapor pressure of the fuel and thus the vaporization and/or boiling temperature of the fuel rises. Therefore, during the hot start of the vehicle, the fuel will not vaporize due to the higher vaporization temperature and it will be possible to feed fuel from the fuel pump to the injector in the high pressure circuit of the fuel system and thus start the engine. FIG. 3 shows how boiling temperature rises when the vapor pressure of ethanol rises. In the atmospheric pressure of 101.3 kPa, the vaporization temperature is about 76° C. When the pressure rises to 200 kPa, the vaporization temperature is about 97° C.

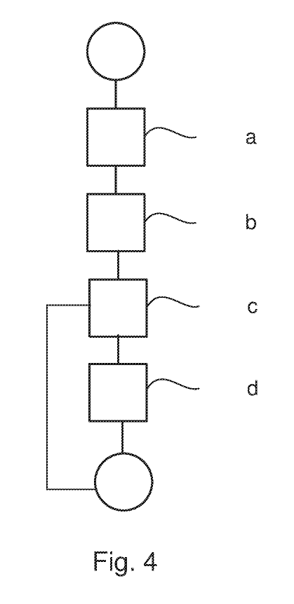

FIG. 4 is a flowchart of a method which comprises the steps:

a) arranging a control valve 30 upstream of the fuel filter device 12 and downstream of the fuel pump 22, in order to control the fuel flow from the fuel pump 22;

b) arranging a check valve 26 upstream of the fuel pump 22 in the first fuel conduit 24 to prevent the fuel from flowing back to the fuel tank 20;

c) controlling the control valve 30 in such a way that it opens at a pre-determined pressure;

wherein a pressure, which is less than the pre-determined opening pressure of the control valve, is built up in the fuel pump 22 after the internal combustion engine 2 is turned off.

By the method the same effects and advantages as described above in connection with the fuel system 4 are obtained. Thus, when the engine 2 is turned off, the fuel in the fuel pump 22 will be pressurized, since the control valve 30 has a pre-determined opening pressure and the check valve 26 will prevent the fuel from flowing back to the fuel tank 20. By the present method it will thus be possible to reduce the risk for vaporization of volatile fuels during the start of a warm or hot internal combustion engine.

The method may further comprise a step of:

d) recirculating a part of the fuel via a recirculation conduit 32 back to the low pressure pump 22.

As mentioned above, in this way the fuel may be recirculated in a closed circuit while it will still be pressurized when the pressure is below the opening pressure of the control valve.

According to one aspect of the invention, the step (b) also comprises controlling the control valve electrically, via a control device connected to the control valve via a communications bus. In this way it will be possible to integrate the control of the control valve to a common vehicle control system

Further, according to one variant, the step c) may comprise providing a valve device at the inlet to the recirculation conduit. In this way it will be possible to control the recirculation flow in an effective way.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. The components and features specified above may within the framework of the invention be combined between different embodiments specified.

1. A fuel system for an internal combustion engine, which fuel system comprises:
a fuel tank;
a fuel pump;
a fuel filter device arranged downstream of the fuel pump;
a first fuel conduit through which the fuel pump is arranged to supply fuel through the fuel filter device;
a control valve, which opens and/or closes at a pre-determined pressure, said control valve arranged upstream of the fuel filter device and downstream of the fuel pump; and
a check valve is arranged upstream of the fuel pump to prevent the fuel from flowing back to the fuel tank.

2. A fuel system according to claim 1, wherein the fuel pump is mechanically driven and controlled by an engine speed of the internal combustion engine.

3. A fuel system according to claim 1, wherein the control valve is configured to gradually open and/or close.

4. A fuel system according to claim 1, further comprising a recirculation conduit is arranged upstream of the control valve and downstream of the fuel pump, said recirculation conduit for recirculation of fuel back to the fuel pump, wherein the check valve is arranged upstream of the fuel pump and the recirculation conduit.

5. A fuel system according to claim 4, wherein the recirculation conduit comprises a regulator for the fuel pump arranged at the inlet of the recirculation conduit, and wherein the control valve operates as a regulator for the fuel pump, and wherein the control valve is located in the first fuel conduit downstream of the fuel pump and upstream of the fuel filter device.

6. A fuel system according to claim 1, wherein the pre-determined pressure at which the control valve opens is below a normal operational pressure of the fuel system.

7. A fuel system according to claim 6, wherein the pre-determined pressure at which the control valve opens is set to a pressure level that increases the vaporization and/or boiling temperature of the fuel.

8. A fuel system according to claim 7, wherein the pre-determined pressure is set to a pressure level such that the vaporization and/or boiling temperature of the fuel is above a temperature of the engine after the engine has been turned off.

9. A fuel system according to claim 1, wherein the pre-determined pressure at which the control valve opens is set to a level in the range of from 1.2 to 2.5 times atmospheric pressure.

10. A fuel system according to claim 1, wherein the pre-determined pressure at which the control valve opens is set to a level such that a vaporization temperature of the fuel is from 10 to 50° C. higher than a vaporization temperature of the fuel at atmospheric pressure.

11. A fuel system according to claim 1, wherein the fuel is ethanol.

12. An internal combustion engine comprising a fuel system comprising:
a fuel tank;
a fuel pump;
a fuel filter device arranged downstream of the fuel pump;
a first fuel conduit through which the fuel pump is arranged to supply fuel through the fuel filter device;
a control valve, which opens and/or closes at a pre-determined pressure, said control valve arranged upstream of the fuel filter device and downstream of the fuel pump; and
a check valve arranged upstream of the fuel pump to prevent the fuel from flowing back to the fuel tank.

13. A method to increase the vaporization temperature of a fuel used in a fuel system for an internal combustion engine, which fuel system comprises a fuel tank, a fuel pump, a fuel filter device arranged downstream of the fuel pump, a first fuel conduit through which the fuel pump is arranged to supply fuel through the fuel filter device, wherein the method comprises the steps:
a) arranging a control valve upstream of the fuel filter device and downstream of the fuel pump, to control the fuel flow from the fuel pump;
b) arranging a check valve upstream of the fuel pump in the first fuel conduit to prevent the fuel from flowing back to the fuel tank; and
c) controlling the control valve to open at a predetermined pressure,
wherein a pressure, which is less than the pre-determined pressure for opening of the control valve, is built up in the fuel pump after the internal combustion engine is turned off.

14. A The method according to claim 13 further comprising:
d) recirculating a part of the fuel via a recirculation conduit back to the low pressure pump.

15. A method according to claim 13, further comprising controlling the control valve electrically, using a control device connected to the control valve via a communications bus.

16. A fuel system according to claim 12, wherein the fuel pump is mechanically driven and controlled by an engine speed of the internal combustion engine.

17. A fuel system according to claim 12, wherein the control valve is configured to gradually open and/or close.

18. A fuel system according to claim 12, further comprising a recirculation conduit arranged upstream of the control valve and downstream of the fuel pump, said recirculation conduit for recirculation of fuel back to the fuel pump, wherein the check valve is arranged upstream of the fuel pump and the recirculation conduit.

19. A fuel system according to claim 18, wherein the recirculation conduit comprises a regulator for the fuel pump arranged at the inlet of the recirculation conduit, and wherein the control valve operates as a regulator for the fuel pump, and wherein the control valve is located in the first fuel conduit downstream of the fuel pump and upstream of the fuel filter device.

20. A fuel system according to claim 12, wherein the pre-determined pressure at which the control valve opens is below a normal operational pressure of the fuel system.
